(19) United States
(12) Patent Application Publication
(10) Pub. No.: US 2008/0269454 A1
(43) Pub. Date: Oct. 30, 2008

(54) Linear thermoplastic polyurethanes and method of fabricating the same

(75) Inventors: Ruei-Shin Chen, Changhua County (TW); Chih Kuang Chang, Kaohsiung County (TW); Yih-Her Chang, Hsinchu City (TW); Fan Jeng Tsai, Hsinchu City (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 12/216,308

(22) Filed: Jul. 2, 2008

Related U.S. Application Data
(63) Continuation-in-part of application No. 11/339,445, filed on Jan. 26, 2006.

(30) Foreign Application Priority Data
Nov. 17, 2005 (TW) 94140418

(51) Int. Cl. C08G 18/72; C08G 18/09

(52) U.S. Cl. 528/67; 528/71; 528/76

(57) ABSTRACT

A linear thermoplastic polyurethane is provided. The linear thermoplastic polyurethane is prepared by starting materials of a difunctional hydrophilic polyether-polyol, 4,4-methylene bisphenyl diisocyanate (MDI) and a difunctional aliphatic polyester-polyol, wherein the starting materials of the linear thermoplastic polyurethane have an NCO:OH ratio of about 0.9:1-1.2:1. The invention also provides a method of fabricating the linear thermoplastic polyurethane.

### CROSS REFERENCE TO RELATED APPLICATIONS

This application is a Continuation-In-Part of pending U.S. patent application Ser. No. 11/339,445, filed Jan. 26, 2006 and entitled “Thermoplastic polyurethanes and method of fabricating the same”.

This Application claims priority of Taiwan Patent Application No. 94140418, filed on Nov. 17, 2005, the entirety of which is incorporated by reference herein.

### BACKGROUND OF THE INVENTION

1. Field of the Invention

The invention relates to a thermoplastic polyurethane, and in particular to a linear thermoplastic polyurethane and a fabrication method thereof.

2. Description of the Related Art

Thermoplastic polyurethane (TPU) is a soft elastomeric resin with high tensile strength, wearproof characteristics, low temperature resistance and strong adhesion. The polyurethane, which meets environmental requirements due to its decomposability and the elimination of using solvents for processing, has been widely applied in textiles and ready-made clothes. A thin (<20 μm) and uniform (±15%) film can be obtained using a blown film method. In the method, to control film quality, a raw material with optimal melting fluidity and narrow molecular weight distribution is required. The most common solvent-based polyurethane fabricated by coating is water vapor permeable polyurethane. Thermoplastic polyurethanes produced in resin factories are also injected-level or extruded-level products. None of the products, however, meet the requirements for blown film processing. Thus, appropriate polyurethane must be separately purchased, increasing costs. To decrease costs, development of blown-level water vapor permeable polyurethane fabrication is required.

Sufficient tensile strength of blown-level polyurethane is required to withstand pulling force during blowing. Aromatic polyol can be conducted to polyurethane to increase film strength. Molecular structure, however, may be destroyed due to simultaneous increase of the resin melting temperature, resulting in deterioration of film quality. Also, the active aromatic polyol may produce undesired side reactions and products with various molecular weights, reducing processing stability. Additionally, softness and water vapor permeability of the film may be simultaneously reduced. However, the addition of a multi-functional-group polyol can improve resin strength due to formation of a cross-linking structure. The cross-linking structure, however, may deteriorate melting fluidity, causing operational difficulties. Furthermore, gel particles formed by the cross-linking structure may block apparatuses or cause defects in the film such as protrusions, scars, or fish eyes.

Current water vapor permeable polyurethane fabrication methods mainly comprise adding hydrophilic functional groups to a polymer structure. Other complementary methods such as adding absorbent powders, creating pores, forming a cross-linking structure, or adding aromatic compounds also increase water vapor permeability or film strength. There are many patents related to water vapor permeable polyurethane, mainly comprising use of additives or film modification by back-end processing. Few, however, relate to the composition of film.

U.S. Pat. No. 6,790,926 discloses a water vapor permeable polyurethane, and fabrication and application thereof. The polyurethane comprises a polyether-polyol containing a high weight percentage of ethylene oxide (comprising polyethylene glycol (PEG) and 4,4-methylene bisphenyl diisocyanate (MDI)), a small molecule chain extender and an araliphatic diol. The addition of the araliphatic diol containing a benzene structure increases resin strength and reduces adhesion between films.

US 2004/092,696 discloses a polyurethane comprising a polyether intermediate containing ethylene oxide (containing two terminal hydroxyl functional groups) and a chain extender such as araliphatic diol. The polyurethane is provided with a high melting temperature, a high tensile strength and anti-static electricity. This patent also discloses a textile combined with the polyurethane, capable of elongation, high water vapor permeability, thermal resistance and processibility.

US 2003/195,293 discloses an aqueous and water vapor permeable polyurethane comprising a polyol containing ethylene oxide. No emulsifying agent or amine neutralizer is required during water dispersion due to formation of the hydrophilic ethylene oxide chains, which prevent pollution from solvents or small molecule vaporized substances. Wound dressing materials or textiles combined therewith also provide high water vapor permeability. Additionally, film strength is improved by the addition of other polymer materials.

JP 2000/220,076 discloses a solvent-based polyurethane containing at least 20 wt % ethylene oxide. To avoid over-concentration of ethylene oxide in a soft segment, a diol chain extender containing ethylene oxide is further added to increase ethylene oxide content in a hard segment. Thus, water vapor permeable groups are uniformly distributed in the polyurethane, increasing film strength.

DE 4,442,380 discloses a polyurethane comprising one or more polyether polyurethanes, one of which is a water vapor permeable polyethylene glycol polyurethane, and other polyurethanes selected by strength requirements. The ethylene oxide content and mixing ratio among the polyether polyurethanes are defined. Polyester polyurethanes, however, are not suitable for use due to its low water vapor permeability.

DE 4,339,475 discloses a polyurethane having 35-60 wt % ethylene oxide comprising polyether-polyol. To facilitate coating, a melt flow index of less than 70 is required. The small molecule chain extender comprises ether-diol and ester-diol. Large molecule polyester-polyol, however, is not used.

U.S. Pat. No. 5,254,641 discloses a water vapor permeable polyurethane film comprising a polyurethane containing polyethylene glycol (PEG) with a hardness of 75A-92A and 5-20 wt % polyether-amide or polyether-ester. Film strength can be effectively improved by the addition of the polyether-amide or polyether-ester.

U.S. Pat. No. 5,283,112 discloses a polyurethane comprising a hydrophilic polyethylene glycol (PEG) and a hydrophobic polydimethyl siloxane (PDMS). During fabrication, phase separation is relatively more complete due to different hydrophilicity of components, resulting in a stronger film. Also, softness of the polyurethane and its adhesion to substrates can be improved by the addition of PDMS.

EP 335,276 discloses a water vapor permeable non-yellowing polyurethane comprising an aliphatic or cyclo-aliphatic diisocyanate, a polyether-polyol containing ethylene oxide, and a diol. The soft polyurethane having an optimal physical modulus can be obtained, suitable for use in extrusion processing.

GB 2,087,909 discloses a solvent-based polyurethane. A short-chain diol is first mixed with exceeding diisocyanate to form a pre-polymer. Next, a polyethylene glycol (PEG) is added thereto. A polyurethane containing 25-40 wt % polyethylene glycol is thus formed. Film strength is improved by formation of the longer hard segment pre-polymer comprising the diol and diisocyanate.

WO 9,000,969, WO 9,000,180, and GB 2,157,703 disclose a two-component or pre-polymer-type polyurethane comprising a polyether-polyol such as a polyethylene glycol (PEG), a chain extender, and a cross-linking reagent. The resulting polyurethane has exceeding NCO and provides low viscosity. Additionally, film strength is increased by formation of a cross-linking structure.

### BRIEF SUMMARY OF THE INVENTION

The invention provides a linear thermoplastic polyurethane prepared by starting materials of a difunctional hydrophilic polyether-polyol, 4,4-methylene bisphenyl diisocyanate (MDI) and a difunctional aliphatic polyester-polyol, wherein the starting materials of the linear thermoplastic polyurethane have an NCO:OH ratio of about 0.9:1-1.2:1.

The invention also provides a method of fabricating a linear thermoplastic polyurethane comprising the sequential steps of mixing a difunctional hydrophilic polyether-polyol and a difunctional aliphatic polyester-polyol to form a mixture, adding a chain extender compound having at least two isocyanate-reactive groups to the mixture and adding 4,4-methylene bisphenyl diisocyanate (MDI) to the mixture to form a linear thermoplastic polyurethane, wherein the difunctional hydrophilic polyether-polyol, the difunctional aliphatic polyester-polyol and the 4,4-methylene bisphenyl diisocyanate (MDI) have an NCO:OH ratio of about 0.9:1-1.2:1.

A detailed description is given in the following embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

The invention provides a linear thermoplastic polyurethane prepared by starting materials of a difunctional hydrophilic polyether-polyol, 4,4-methylene bisphenyl diisocyanate (MDI) and a difunctional aliphatic polyester-polyol. The starting materials of the linear thermoplastic polyurethane have an NCO:OH ratio of about 0.9:1-1.2:1. The difunctional hydrophilic polyether-polyol has a C:O ratio of about 2:1-2.4:1.

The difunctional hydrophilic polyether-polyol may have a weighted average molecular weight of about 800-4,000 and comprise polyethylene glycol (PEG), polypropylene glycol (PPG) or polytetramethylene glycol (PTMG). In the linear thermoplastic polyurethane, the difunctional hydrophilic polyether-polyol has a weight ratio of about 20-60%.

The difunctional aliphatic polyester-polyol may have a weighted average molecular weight of about 800-4,000 and comprise poly(1,4-butylene adipate) (PBA). In the linear thermoplastic polyurethane, the difunctional aliphatic polyester-polyol has a weight ratio of about 10-40%.

The 4,4-methylene bisphenyl diisocyanate (MDI) has a weight ratio of about 20-40% in the linear thermoplastic polyurethane.

The linear thermoplastic polyurethane may further comprise a chain extender compound having at least two isocyanate-reactive groups, such as 1,4-butane diol (1,4-BD). The chain extender compound may have a weighted average molecular weight less than 800. In the linear thermoplastic polyurethane, the chain extender compound has a weight ratio of about 5-15%.

The linear thermoplastic polyurethane may have a weighted average molecular weight of about 150,000-250,000 or 180,000-200,000, a polydispersity index (PDI) of about 1.6-2.4 or 1.8-2.0, a melt flow index of about 6,000-12,000 ps or 8,000-10,000 ps, a water vapor permeability of about 2,500-15,000 g/m²/day, a tensile strength of about 250-500 kg/cm², an elongation of about 500-750% and a 100% modulus of about 30-70 kg/cm².

Unlike a conventional thermoplastic polyurethane composed of aromatic polyol or multi-functional-group polyol to increase film mechanical strength, the invention provides a linear thermoplastic polyurethane composed of a difunctional hydrophilic polyether-polyol and a difunctional aliphatic polyester-polyol capable of forming more hydrogen bonds and intermolecular interaction forces. Thus, the novel linear thermoplastic polyurethane of the invention provides higher water vapor permeability and better film processibility, overcoming the issues associated with blown film processing.

The invention also provides a method of fabricating a linear thermoplastic polyurethane, comprising the following steps. A difunctional hydrophilic polyether-polyol and a difunctional aliphatic polyester-polyol are mixed to form a mixture at 40-100° C. The difunctional aliphatic polyester-polyol has a concentration of about 10-40 wt %. The difunctional hydrophilic polyether-polyol has a C:O ratio of about 2:1-2.4:1. The difunctional hydrophilic polyether-polyol may comprise polyethylene glycol (PEG), polypropylene glycol (PPG) or polytetramethylene glycol (PTMG). The difunctional aliphatic polyester-polyol may have a weighted average molecular weight of about 800-4,000 and comprise poly(1,4-butylene adipate) (PBA). Next, a chain extender compound having at least two isocyanate-reactive groups is added to the mixture. Finally, 4,4-methylene bisphenyl diisocyanate (MDI) is added to the mixture to form a linear thermoplastic polyurethane. The difunctional hydrophilic polyether-polyol, the difunctional aliphatic polyester-polyol and the 4,4-methylene bisphenyl diisocyanate (MDI) have an NCO:OH ratio of about 0.9:1-1.2:1.

### EXAMPLE 1

135 g polyethylene glycol (PEG) and 45 g poly(1,4-butylene adipate) (PBA) were mixed in a reaction tank with stirring under nitrogen gas at 69° C. Next, 20.25 g 1,4-butane diol (1,4-BD), a chain extender, was added to the mixture and continuously stirred. 78.75 g 4,4-methylene bisphenyl diisocyanate (MDI) was finally added to the mixture and rapidly stirred, then the mixture was exothermic and drew out at 120° C. The result was then cured in an oven at 80° C. for 24 hours. Thus, obtaining a water vapor permeable linear thermoplastic polyurethane.

The linear thermoplastic polyurethane comprised 48 wt % PEG2000, 17 wt % PBA2000, 7 wt % 1,4-BD and 28 wt % MDI. The linear thermoplastic polyurethane had 100% modulus of 31 kg/cm², elongation of 740%, tensile strength of 310 kg/cm² and water vapor permeability of 13,000 g/m²/day.

### EXAMPLE 2

120 g polyethylene glycol (PEG) and 40 g poly(1,4-butylene adipate) (PBA) were mixed in a reaction tank with stirring under nitrogen gas at 67° C. Next, 21.6 g 1,4-butane diol (1,4-BD), a chain extender, was added to the mixture and continuously stirred. 80 g 4,4-methylene bisphenyl diisocyanate (MDI) was finally added to the mixture and rapidly stirred, then the mixture was exothermic and drew out at 120° C. The result was then cured in an oven at 80° C. for 24 hours. Thus, obtaining a water vapor permeable linear thermoplastic polyurethane.

The linear thermoplastic polyurethane comprised 46 wt % PEG2000, 15 wt % PBA2000, 8 wt % 1,4-BD and 31 wt % MDI. The linear thermoplastic polyurethane had 100% modulus of 40 kg/cm², elongation of 700%, tensile strength of 240 kg/cm² and water vapor permeability of 12,000 g/m²/day.

### EXAMPLE 3

110 g polyethylene glycol (PEG) and 55 g poly(1,4-butylene adipate) (PBA) were mixed in a reaction tank with stirring under nitrogen gas at 62° C. Next, 24.75 g 1,4-butane diol (1,4-BD), a chain extender, was added to the mixture and continuously stirred. 89.38 g 4,4-methylene bisphenyl diisocyanate (MDI) was finally added to the mixture and rapidly stirred, then the mixture was exothermic and drew out at 120° C. The result was then cured in an oven at 80° C. for 24 hours. Thus, obtaining a water vapor permeable linear thermoplastic polyurethane.

The linear thermoplastic polyurethane comprised 39 wt % PEG2000, 20 wt % PBA2000, 9 wt % 1,4-BD and 32 wt % MDI. The linear thermoplastic polyurethane had 100% modulus of 50 kg/cm², elongation of 650%, tensile strength of 320 kg/cm² and water vapor permeability of 10,500 g/m²/day.

### EXAMPLE 4

100 g polyethylene glycol (PEG) and 58.8 g poly(1,4-butylene adipate) (PBA) were mixed in a reaction tank with stirring under nitrogen gas at 65° C. Next, 25.1 g 1,4-butane diol (1,4-BD), a chain extender, was added to the mixture and continuously stirred. 89.7 g 4,4-methylene bisphenyl diisocyanate (MDI) was finally added to the mixture and rapidly stirred, then the mixture was exothermic and drew out at 120° C. The result was then cured in an oven at 80° C. for 24 hours. Thus, obtaining a water vapor permeable linear thermoplastic polyurethane.

The linear thermoplastic polyurethane comprised 37 wt % PEG2000, 21 wt % PBA2000, 9 wt % 1,4-BD and 33 wt % MDI. The linear thermoplastic polyurethane had 100% modulus of 61 kg/cm², elongation of 630%, tensile strength of 330 kg/cm² and water vapor permeability of 8,800 g/m²/day.

### EXAMPLE 5

97 g polyethylene glycol (PEG) and 60.6 g poly(1,4-butylene adipate) (PBA) were mixed in a reaction tank with stirring under nitrogen gas at 67° C. Next, 27.3 g 1,4-butane diol (1,4-BD), a chain extender, was added to the mixture and continuously stirred. 96.5 g 4,4-methylene bisphenyl diisocyanate (MDI) was finally added to the mixture and rapidly stirred, then the mixture was exothermic and drew out at 120° C. The result was then cured in an oven at 80° C. for 24 hours. Thus, obtaining a water vapor permeable linear thermoplastic polyurethane.

The linear thermoplastic polyurethane comprised 34 wt % PEG2000, 22 wt % PBA2000, 10 wt % 1,4-BD and 34 wt % MDI. The linear thermoplastic polyurethane had 100% modulus of 67 kg/cm², elongation of 570%, tensile strength of 280 kg/cm² and water vapor permeability of 8,200 g/m²/day.

### EXAMPLE 6

91 g polyethylene glycol (PEG) and 75 g poly(1,4-butylene adipate) (PBA) were mixed in a reaction tank with stirring under nitrogen gas at 64° C. Next, 23.6 g 1,4-butane diol (1,4-BD), a chain extender, was added to the mixture and continuously stirred. 87.5 g 4,4-methylene bisphenyl diisocyanate (MDI) was finally added to the mixture and rapidly stirred, then the mixture was exothermic and drew out at 120° C. The result was then cured in an oven at 80° C. for 24 hours. Thus, obtaining a water vapor permeable linear thermoplastic polyurethane.

The linear thermoplastic polyurethane comprised 33 wt % PEG2000, 26 wt % PBA2000, 9 wt % 1,4-BD and 32 wt % MDI. The linear thermoplastic polyurethane had 100% modulus of 53 kg/cm², elongation of 510%, tensile strength of 480 kg/cm² and water vapor permeability of 8,000 g/m²/day.

### EXAMPLE 7

80 g polyethylene glycol (PEG) and 80 g poly(1,4-butylene adipate) (PBA) were mixed in a reaction tank with stirring under nitrogen gas at 62° C. Next, 25.2 g 1,4-butane diol (1,4-BD), a chain extender, was added to the mixture and continuously stirred. 90 g 4,4-methylene bisphenyl diisocyanate (MDI) was finally added to the mixture and rapidly stirred, then the mixture was exothermic and drew out at 120° C. The result was then cured in an oven at 80° C. for 24 hours. Thus, obtaining a water vapor permeable linear thermoplastic polyurethane.

The linear thermoplastic polyurethane comprised 29 wt % PEG2000, 29 wt % PBA2000, 9 wt % 1,4-BD and 33 wt % MDI. The linear thermoplastic polyurethane had 100% modulus of 64 kg/cm², elongation of 570%, tensile strength of 370 kg/cm² and water vapor permeability of 2,600 g/m²/day.

### COMPARATIVE EXAMPLE 1

160 g polyethylene glycol (PEG) was added in a reaction tank under nitrogen gas at 74° C. Next, 21.6 g 1,4-butane diol (1,4-BD), a chain extender, was added to the mixture and continuously stirred. 80 g 4,4-methylene bisphenyl diisocyanate (MDI) was finally added to the mixture and rapidly stirred, then the mixture was exothermic and drew out at 120° C. The result was then cured in an oven at 80° C. for 24 hours. Thus, obtaining a thermoplastic polyurethane.

The thermoplastic polyurethane comprised 61 wt % PEG2000, 8 wt % 1,4-BD and 31 wt % MDI. The thermoplastic polyurethane had 100% modulus of 35 kg/cm², elongation of 750%, tensile strength of 150 kg/cm² and water vapor permeability of 14,000 g/m²/day.

Compared to the conventional thermoplastic polyethylene without PBA, the inventive linear thermoplastic polyurethane of the invention provides higher tensile strength and maintains high water vapor permeability. Accordingly, resin strength is effectively improved by addition of the PBA. The experimental data are recited in Table 1. Other modified polyurethane fabrication methods may comprise alteration of the order of adding the raw materials, use of a solvent or not, batch synthesis, or twin screw extrusion, but are not limited thereto.

TABLE 1

| Composition | | | | | Property | | | |
|---|---|---|---|---|---|---|---|---|
| | | | | | 100% | | Tensile | Water vapor |
| | PEG2000 | PBA2000 | 1,4-BD | MDI | modulus | Elongation | strength | permeability |
| No. | (wt %) | (wt %) | (wt %) | (wt %) | (kg/cm²) | (%) | (kg/cm²) | (g/m²/day) |
| Comparative | 61 | 0 | 8 | 31 | 35 | 750 | 150 | 14,000 |
| Example 1 | | | | | | | | |
| Example 1 | 48 | 17 | 7 | 28 | 31 | 740 | 310 | 13,000 |
| Example 2 | 46 | 15 | 8 | 31 | 40 | 700 | 240 | 12,000 |
| Example 3 | 39 | 20 | 9 | 32 | 50 | 650 | 320 | 10,500 |
| Example 4 | 37 | 21 | 9 | 33 | 61 | 630 | 330 | 8800 |
| Example 5 | 34 | 22 | 10 | 34 | 67 | 570 | 280 | 8200 |
| Example 6 | 33 | 26 | 9 | 32 | 53 | 510 | 480 | 8000 |
| Example 7 | 29 | 29 | 9 | 33 | 64 | 570 | 370 | 2600 |

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A linear thermoplastic polyurethane prepared by starting materials of a difunctional hydrophilic polyether-polyol, 4,4-methylene bisphenyl diisocyanate (MDI) and a difunctional aliphatic polyester-polyol, wherein the starting materials of the linear thermoplastic polyurethane have an NCO:OH ratio of about 0.9:1-1.2:1.

2. The linear thermoplastic polyurethane as claimed in claim 1, wherein the difunctional hydrophilic polyether-polyol has a C:O ratio of about 2:1-2.4:1.

3. The linear thermoplastic polyurethane as claimed in claim 1, wherein the difunctional hydrophilic polyether-polyol comprises polyethylene glycol (PEG), polypropylene glycol (PPG) or polytetramethylene glycol (PTMG).

4. The linear thermoplastic polyurethane as claimed in claim 1, wherein the difunctional hydrophilic polyether-polyol has a weight ratio of about 20-60%.

5. The linear thermoplastic polyurethane as claimed in claim 1, wherein the difunctional aliphatic polyester-polyol has a weighted average molecular weight of about 800-4,000.

6. The linear thermoplastic polyurethane as claimed in claim 1, wherein the difunctional aliphatic polyester-polyol comprises poly(1,4-butylene adipate) (PBA).

7. The linear thermoplastic polyurethane as claimed in claim 1, wherein the difunctional aliphatic polyester-polyol has a weight ratio of about 10-40%.

8. The linear thermoplastic polyurethane as claimed in claim 1, further comprising a chain extender compound having at least two isocyanate-reactive groups.

9. The linear thermoplastic polyurethane as claimed in claim 1, wherein the linear thermoplastic polyurethane has a weighted average molecular weight of about 150,000-250,000.

10. The linear thermoplastic polyurethane as claimed in claim 1, wherein the linear thermoplastic polyurethane has a polydispersity index (PDI) of about 1.6-2.4.

11. The linear thermoplastic polyurethane as claimed in claim 1, wherein the linear thermoplastic polyurethane has a water vapor permeability of about 2,500-15,000 g/m²/day.

12. The linear thermoplastic polyurethane as claimed in claim 1, wherein the linear thermoplastic polyurethane has a tensile strength of about 250-500 kg/cm².

13. The linear thermoplastic polyurethane as claimed in claim 1, wherein the linear thermoplastic polyurethane has an elongation of about 500-750%.

14. The linear thermoplastic polyurethane as claimed in claim 1, wherein the linear thermoplastic polyurethane has a 100% modulus of about 30-70 kg/cm².

15. A method of fabricating a linear thermoplastic polyurethane, comprising the sequential steps of:
mixing a difunctional hydrophilic polyether-polyol and a difunctional aliphatic polyester-polyol to form a mixture;
adding a chain extender compound having at least two isocyanate-reactive groups to the mixture; and
adding 4,4-methylene bisphenyl diisocyanate (MDI) to the mixture to form a linear thermoplastic polyurethane, wherein the difunctional hydrophilic polyether-polyol, the difunctional aliphatic polyester-polyol and the 4,4-methylene bisphenyl diisocyanate (MDI) have an NCO:OH ratio of about 0.9:1-1.2:1.

16. The method of fabricating a linear thermoplastic polyurethane as claimed in claim 15, wherein the difunctional aliphatic polyester-polyol has a concentration of about 10-40 wt %.

17. The method of fabricating a linear thermoplastic polyurethane as claimed in claim 15, wherein the difunctional hydrophilic polyether-polyol has a C:O ratio of about 2:1-2.4:1.

18. The method of fabricating a linear thermoplastic polyurethane as claimed in claim 15, wherein the difunctional hydrophilic polyether-polyol comprises polyethylene glycol (PEG), polypropylene glycol (PPG) or polytetramethylene glycol (PTMG).

19. The method of fabricating a linear thermoplastic polyurethane as claimed in claim 15, wherein the difunctional aliphatic polyester-polyol has a weighted average molecular weight of about 800-4,000.

20. The method of fabricating a linear thermoplastic polyurethane as claimed in claim 15, wherein the difunctional aliphatic polyester-polyol comprises poly(1,4-butylene adipate) (PBA).
